(19) United States
(12) Patent Application Publication
(10) Pub. No.: US 2003/0226042 A1
(43) Pub. Date: Dec. 4, 2003

(54) Card authentication server apparatus and card authentication program

(76) Inventor: Takafumi Fukushima, Fuji-shi (JP)

Correspondence Address: HARNESS, DICKEY & PIERCE, P.L.C., P.O. BOX 828, BLOOMFIELD HILLS, MI, 48303, US

(21) Appl. No.: 10/447,001

(22) Filed: May 28, 2003

(30) Foreign Application Priority Data
May 29, 2002 (JP) 2002-156107
May 1, 2003 (JP) 2003-126480

(51) Int. Cl. H04L 9/00

(52) U.S. Cl. 713/202; 713/159

(57) ABSTRACT

On receiving the declaration of use of a card from a card user, a user authentication processing section executes authentication to determine whether or not the use has been declared by the valid owner of the card. On confirming that the use has been declared y the valid owner, the user authentication processing section permits the use of the card and stores this information in an owner database. On the other hand, on receiving an approval inquiry from a card-available store via a network about a card to be used for settlement, a card settlement processing section determines whether or not the use of the card is permitted, with reference to the owner database. On confirming that the use is permitted, the card settlement processing section transmits a use permission response to the card-available store through the network.

### CROSS-REFERENCE TO RELATED APPLICATIONS

This application is based upon and claims the benefit of priority from the prior Japanese Patent Applications No. 2002-156107, filed May 29, 2002; and No. 2003-126480, filed May 1, 2003, the entire contents of both of which are incorporated herein by reference.

### BACKGROUND OF THE INVENTION

1. Field of the Invention

The present invention relates to a card authentication server apparatus and a card authentication program that respond to an approval inquiry from a card-available store about a credit card, a debit card (cache card), or another card which is used for settlement, to notify the store whether or not to permit the use of that card.

2. Description of the Related Art

For example, on receiving an approval inquiry from a card-available store about a credit card used for settlement, a conventional card authentication server apparatus that determines whether or not to permit the use of a credit card examines the reliability of that card, for example, whether or not it has reportedly been lost or stolen. Then, on determining that the card is reliable, the apparatus notifies the card-available store that the use of the card is permitted. Thus, as long as the card is genuine, it is permitted to be used even if the card user does not actually own the card. Thus, it has been impossible to prevent the unfair use of the card.

Thus, the card-available store asks the card user to sign if the use of the card has been permitted, to check whether or not the card user actually owns the card. However, individuals cannot be sufficiently authenticated using only the signature.

In view of these circumstances, according to Jpn. Pat. Appln. KOKAI Publication No. 2001-306806, when it is checked whether a card user who uses a card at a card-available store actually owns the card, a center of a card company receives a card number read by a terminal at the card-available store and retrieves, on the basis of the card number, the telephone number of the card owner's mobile communication terminal such as a cellular telephone which number is already registered in a database. The center then transmits information to a terminal with that telephone number. Then, if this terminal inputs information to the center indicating that the card may be permitted to be used, then the center determines that the card user actually owns the card to permit the use of the card.

However, according to the above publication, to check whether or not the card user who has requested the card-available store to use the card for settlement actually owns the card, the card company transmits, in response to the approval inquiry from the card-available store, information to the telephone number of the mobile communication terminal already registered by the card owner. Then, the card company must wait for the mobile communication terminal with this telephone number to input information to the company indicating that the use of the card may be permitted. Thus, the card-available store is forced to suspend the settlement process all the while. In particular, if the card user takes much time to look for his or her mobile communication terminal or leaves it in his or her car parked in a parking lot, the suspension time is markedly long. In general, if the settlement process at the store takes much time, the client must wait long. This may lead to the loss of other clients' purchase opportunities.

Further, even if the card user actually owns the card, if he or she does not carry his or her mobile communication terminal with him or her, the owner's approval is not obtained. Thus, the use of the card is not permitted. In such a case, the card-available store must ask the client to change the settlement method or identity the card user through his or her signature. Disadvantageously, in the former case, serviceability may be degraded to lose some clients. In the latter case, the unfair use of the card cannot be prevented. In other words, to prevent the unfair use of the card, the card user must always carry his or her mobile communication terminal such as a cellular telephone with him or her. This is not practical.

### BRIEF SUMMARY OF THE INVENTION

It is an object of the present invention to provide a practical card authentication apparatus and a practical card authentication program that can reliably prevent a card from being unfairly used while allowing a settlement process to be smoothly executed at a card-available store.

According to an aspect of the present invention, there is provided a card authentication server apparatus that responds to an approval inquiry from a card-available store about a card used for settlement (for example, a credit card or a debit card) to notify the store whether or not to permit the use of that card. This card authentication apparatus is connected to the card-available store via a network. On receiving a declaration of use of this card from the card user, the apparatus executes authentication to determine whether or not the use has been declared by the valid owner of the card. If it is determined that the use has been declared by the valid owner, the apparatus permits the card to be used. On the other hand, on receiving an approval inquiry from the card-available store about a card used for settlement, the apparatus checks whether or not the use of the card is permitted. If it is determined that the use of the card is permitted, the apparatus transmits a use permission response to the card-available store through the network.

With such a configuration, only a short time is required at the card-available store to check whether or not the card user actually owns the card. This is because this time corresponds to the time required by the card authentication server apparatus to check whether or not the card about which the card-available store is inquiring has already been permitted to be used. Thus, the flow of the settlement process is not suspended. Further, the card user is not asked to sign when using the card at the card-available store and need not carry his or her mobile communication terminal such as a cellular telephone with him or her. Therefore, the present invention is practical.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a diagram showing a configuration of a system according to a first and second embodiments of the present invention;

FIG. 2 is a block diagram showing a configuration of essential parts of a card authentication server according to each embodiment of the present invention;

FIG. 3 is a table showing the structure of data in an owner database possessed by the card authentication server according to the first embodiment;

FIG. 4 is a table showing the structure of data in an unfairness database possessed by the card authentication server according to each embodiment;

FIG. 5 is a flow chart showing a process procedure executed by a user authentication processing section of the card authentication server according to the first embodiment;

FIG. 6 is a flow chart showing a process procedure executed by a card settlement processing section of the card authentication server according to the first embodiment;

FIG. 7 is a table showing the structure of data in an owner database possessed by the card authentication server according to the second embodiment;

FIG. 8 is a flow chart showing a process procedure executed by a user authentication processing section of the card authentication server according to the second embodiment;

FIG. 9 is a flow chart showing a process procedure executed by a card settlement processing section of the card authentication server according to the second embodiment;

FIG. 10 is a diagram showing a system according to a third embodiment;

FIG. 11 is a table showing a status table stored in an owner database according to the third embodiment;

FIG. 12 is a flow chart showing essential parts of a process procedure executed by a user authentication processing section of the card authentication server according to the third embodiment;

FIG. 13 is a flow chart showing a process procedure executed by a card settlement processing section of the card authentication server according to the third embodiment;

FIG. 14 is a diagram showing an Internet system to which the present card authentication server is connected; and

FIG. 15 is a diagram showing an Internet system to which the present card authentication server is connected.

### DETAILED DESCRIPTION OF THE INVENTION

Embodiments of the present invention will be described below with reference to the drawings.

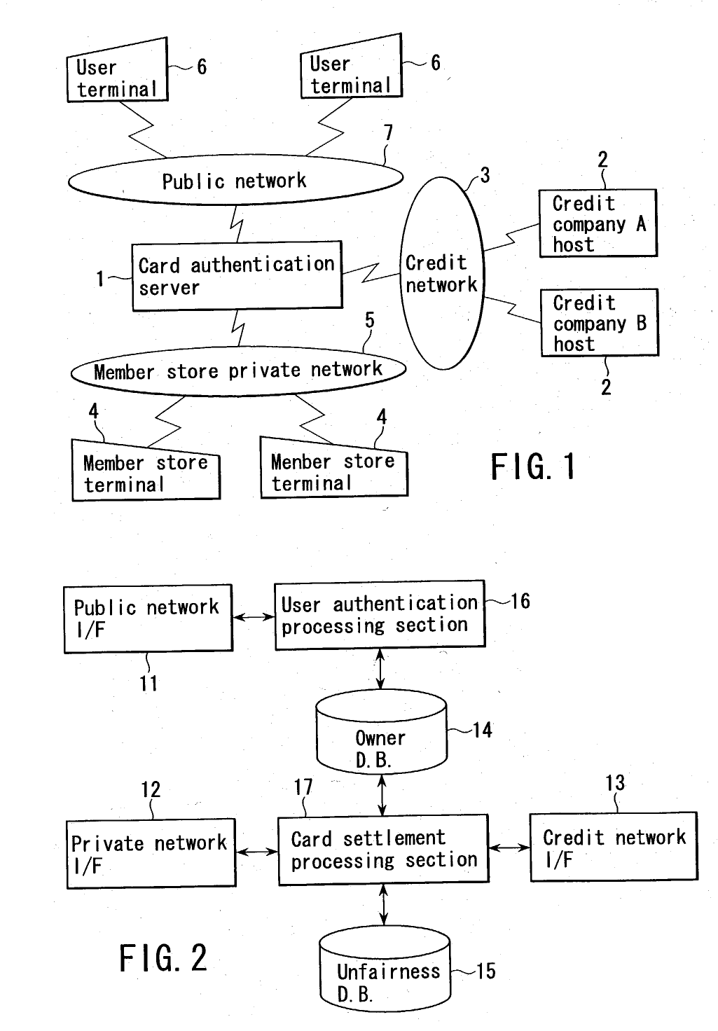

First, a first embodiment will be described with reference to FIGS. 1 to 6. This embodiment is applied to, for example, a card-available store that is a member store that settles charges using credit cards.

FIG. 1 is a view showing a configuration of a system according to this embodiment. A card authentication server apparatus 1 is located at, for example, a card use management center intermediating between each member store and each credit card issuing company. Further, the card authentication server apparatus 1 and a host computer 2 at each credit card issuing company are connected by a credit network 3 that is a private network. Furthermore, the card authentication server apparatus 1 and a member store terminal 4 at each member store are connected by a member store private network 5 that is also an private network.

Further, the card authentication server apparatus 1 is connected by a public network 7 such as a telephone network or the Internet to a user terminal 6 used by each credit card user.

The member store terminal 4 is a computer terminal having a function of processing settlement based on a credit card. The member store terminal 4 corresponds to a POS (Point Of Sales) integrated terminal having a credit exclusive terminal and a product sale registration function. The member store terminal 4 comprises at least a card reader that reads a card number recorded on a credit card, a keyboard through which the amount of a credit, a payment method, and the like are inputted, and a printer that prints and issues credit slips. When a price settlement based on a credit card is declared, the member store terminal 4 makes an approval inquiry about this credit card by transmitting credit settlement information to the card authentication server apparatus 1 including the card number of the credit card, the amount of the credit, and the payment method. Then, when the card authentication server apparatus transmits a use permission response for this credit card to the member store terminal 4, the terminal 4 prints and issues a credit slip.

A user terminal 6 is a communication terminal used by the credit card user to declare to the card authentication server apparatus 1 the use of his or her own credit card before the credit card user actually uses the card. The user terminal 6 may be, for example, a desktop telephone, a public telephone, or an Internet-compatible personal computer. Alternatively, the user terminal 6 may be a cellular telephone, a PHS (Personal Handyphone System), a PDA (Personal Digital Assistants), or the like, but need not be portable.

FIG. 2 is a block diagram showing a configuration of essential functions of the card authentication server apparatus 1. The card authentication server apparatus 1 comprises a public network interface 11 connected to the public network 7, a private network interface 12 connected to the member store private network 5, and a credit network interface 13 connected to the credit network 3.

Further, the card authentication server apparatus 1 stores and retains an owner database 14 and an unfairness database 15 in an auxiliary storage device such as an HDD (Hard Disk Drive).

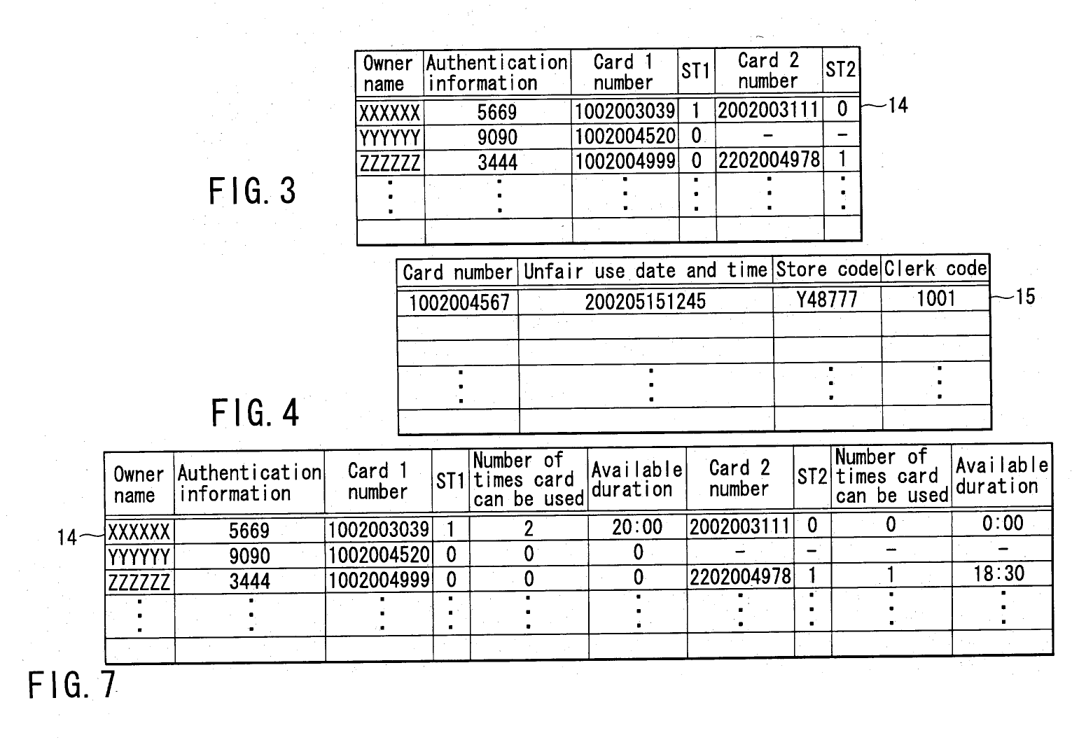

The owner database 14 as a user information storage section stores, for each name of a credit card owner who owns at least one regular credit card issued by each credit card issuing company, authentication information (for example, a code number) arbitrarily set by the card owner, the card numbers of all credit cards owned by the card owner, and status information on each credit card as shown in FIG. 3. The status information indicates whether the credit card with the corresponding card number is permitted to be used. Status=1 indicates that the use of the credit card is permitted. Status=0 indicates that the use of the credit card is not permitted.

The unfairness database 15 stores the card number of an unfairly used credit card, the time at which the card was unfairly used as shown in FIG. 4, a store code for the member store at which the card was unfairly used, and a clerk code for the clerk who handled the card.

Furthermore, the card authentication server apparatus 1 comprises a user authentication processing section 16 that carries out authentication to determine whether or not the credit card user is the regular owner of the credit card, with reference to the owner database 14 on the basis of information inputted by the user terminal 6 via the public network interface 11, and a card settlement processing section 17 that authenticates the credit card with reference to the owner database 14 on the basis of information inputted by the member store terminal 4 via the private network interface 12 to complete a credit process if the card is genuine, while updating the unfairness database 15 to inhibit deals if the card is invalid. The user authentication processing section 16 and the card settlement processing section 17 are each composed of a CPU (Central Processing Unit), a ROM (Read Only Memory), a RAM (Random Access Memory), and the like.

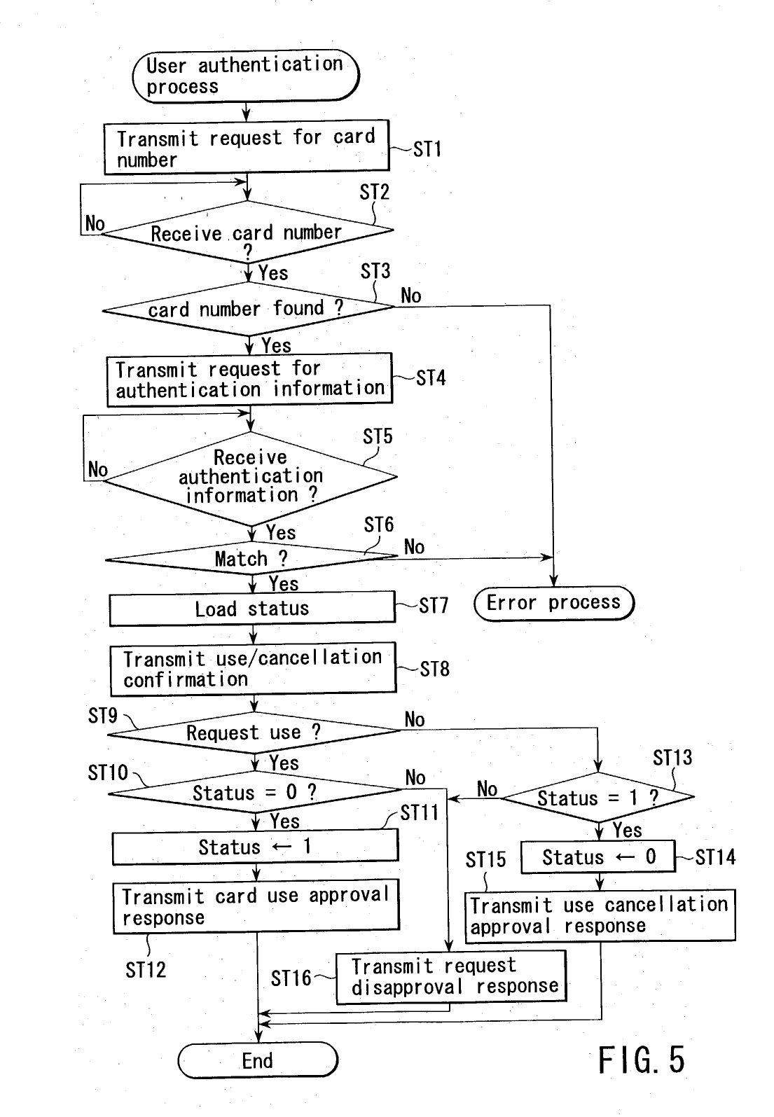

FIG. 5 is a flow chart showing a process procedure executed by the user authentication processing section 16. The user authentication processing section 16 is connected to the user terminal 6 via the public network interface 11, and the user terminal 6 inputs a code number to the user authentication processing section 16 indicating the preset declaration of use of the credit card. Then, the user authentication processing section 16 starts this process.

First, at step ST1, the user authentication processing section 16 provides the credit card user using the user terminal 6 with an audio guidance that requests the user to input the card number of the credit card to be used. This audio guidance is, for example, the message “Input the card number of your credit card”. At step ST2, in response to this notification, the user inputs the card number from the user terminal 6. Then, at step ST3, the user authentication processing section 16 searches the owner database 14 to determine whether or not the card number inputted from the user terminal 6 is stored in the database 14.

If the card number is stored in the owner database 14, then at step ST4, the user authentication processing section 16 loads owner name information and authentication information stored in association with the card number. The user authentication processing section 16 then provides the credit card user with an audio guidance requesting him or her to input authentication information. This audio guidance is, for example, the message “Input the code number of XXXXX (owner name)”. At step ST4, in response to this notification, the user inputs authentication information from the user terminal 6. Then, at step ST6, the user authentication processing section 16 checks the inputted authentication information against the authentication information loaded from the owner database 14. As a result, if both pieces of information match each other, the user authentication processing section 16 determines that the use has been declared by the valid owner of the credit card identified by the inputted card number. The procedure proceeds to step ST7.

At step ST7, the user authentication processing section 16 loads status information corresponding to the card number, from the owner database 14. Further, at step ST8, the user authentication processing section 16 provides the credit card user with an audio guidance asking him or her whether this is the declaration of use of the credit card or the cancellation of the past use declaration. This audio guidance is, for example, the message “Input “1” to declare the use of the credit card or “9” to cancel the use declaration. At step ST9, in response to this notification, the user inputs information requesting the declaration of use of the credit card. Then, at step ST10, the user authentication processing section 16 examines the status information loaded from the owner database 14. If the status information is “0 (unavailable)”, then at step ST11, the user authentication processing section 16 changes this status information to “1 (available)” and then writes the changed information in the owner database 14. Further, at step ST12, the user authentication processing section 16 provides the credit card user with an audio message indicating that the use of the credit card has been approved, thus completing the process. This audio message is, for example, “The use of the credit card with the card number zzzzzzzzzz owned by XXXX (owner name) has been approved”.

On the other hand, if at step ST9, the user terminal 6 inputs information to the user authentication processing section 16 requesting the use declaration to be cancelled, then at step ST13, the user authentication processing section 16 examines the status information loaded from the owner database 14. Then, if the status information is “1 (available)”, then at step ST14, the user authentication processing section 16 changes the status information to “0 (unavailable)” and then writes the changed information in the owner database 14. Further, at step ST15, the user authentication processing section 16 provides the credit card user with an audio message indicating that the declaration of use of the credit card has been cancelled, to complete the process. This audio message is, for example, “the declaration of the credit card with the card number zzzzzzzzzz owned by XXXX (owner name) has been cancelled”.

If the status information is 11111 at step ST10 or “0” at step ST13, then at step ST16, the user authentication processing section 16 provides the credit card user with an audio message indicating that the request made by the credit card user will not be fulfilled, to complete the process. This audio message is, for example, “The request made by XXXXX (owner name) will not be fulfilled”.

Further, if at step ST3, the card number is not stored in the owner database 14 and if at step ST6, the two pieces authentication information do not match each other, the user authentication processing information 16 executes an error process. It is contemplated that the error process may comprise prompting the user to reenter the preceding card number or authentication information, and if the two pieces of information still fail to match each other, forcibly disconnecting the line to the user terminal 6.

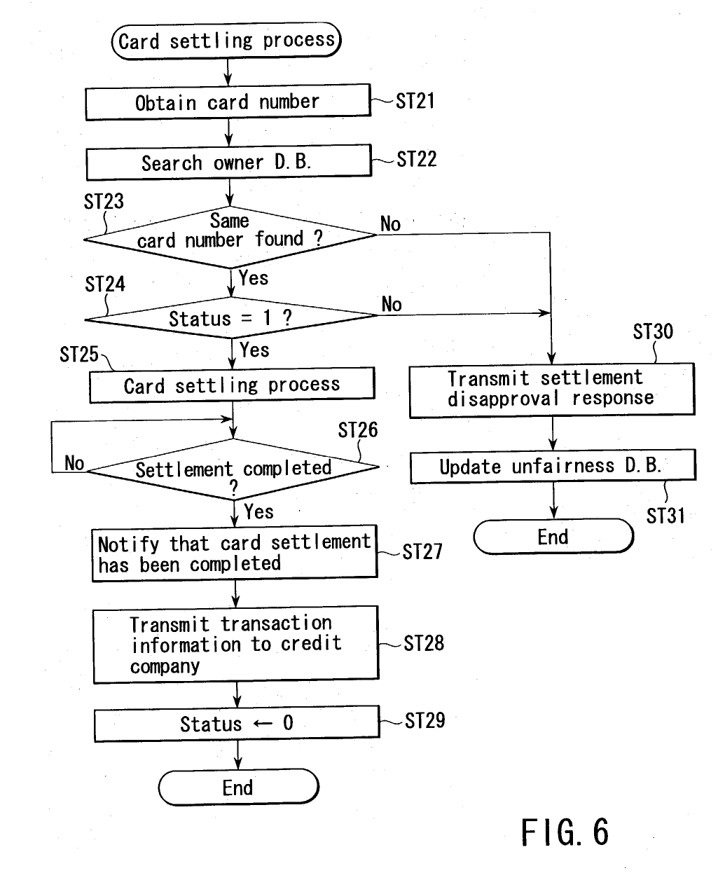

FIG. 6 is a flow chart showing a process procedure executed by the card settlement processing section 17. The card settlement processing section 17 is connected to the member store terminal 4 via the private network interface 12 and then receives credit settlement information such as a credit card number, the amount of a credit, a payment method, a store code, a clerk code, and transaction date and time information. Then, the card settlement processing section starts this process.

First, at step ST21, the card settlement processing section 17 obtains a card number form the credit settlement information received from the member store terminal 4. Then, at step ST22, the card settlement processing section 17 searches the owner database 14 to determine whether or not this card number is stored in the database 14.

If at step ST23, it is confirmed that the owner database 14 stores the same card number as that obtained from the credit settlement information, then at step ST24, the card settlement processing section determines whether or not status information stored in association with this card number is “1”. As a result, if the status information is “1”, the credit card with this card number is permitted to be used. Accordingly, the card settlement processing section 17 executes a normal card settlement process on the basis of the credit information received from the member store terminal 4.

Subsequently, once the card settlement process is completed at step ST26, the card settlement processing section 17 transmits a response message to the member store terminal 4 indicating the card settlement has been completed. Further, at step ST28, the card settlement processing section 17 transmits information such as the card number of the card for which the price has been settled, the amount of the credit, the payment method, the transaction date and time, and the store code, via the credit network interface 13 to the host computer 2 of the credit card issuing company that has issued the credit card with this card number. Subsequently, at step ST 29, the card settlement processing section 17 changes the status information stored in the owner database 14 in association with the card number, to “0”. The card settlement processing section 17 then writes the changed information in the owner database 14 to complete the process.

On the other hand, if at step ST23, the owner database 14 does not store the same card number as that obtained from the credit settlement information and if at step ST24, the status information stored in association with this card number is “0”, then at step ST30, the card settlement processing section 17 transmits a response message to the member store terminal 4 indicating that the price cannot be settled with this card. This is because the use of this credit card has not been declared. Subsequently, the card settlement processing section 17 records information such as this card number, the transaction date and time (unfair use date and time), the store code, and the clerk code in the unfairness database 15 to complete the process.

With the present embodiment configured as described above, a credit card owner who desires to go shopping at a member store using a valid credit card calls the card use management center using a pushbutton phone type desktop telephone before going out. If the owner gets the card use management center, he or she uses dial buttons to input a code number indicating the preset declaration of use of the credit card. Then, the card authentication server apparatus 1 at the card use management center issues an audio guidance asking for the card number of the credit card. Thus, the credit card owner uses the dial buttons to input the card number of the credit cared used for shopping. Then, the card authentication server apparatus 1 issues an audio guidance requesting authentication information to be inputted. Thus, the credit card owner uses the dial buttons to input authentication information (a code number) previously registered in the card use management center. Then, the card authentication server apparatus 1 issues an audio guidance checking whether or not this is the declaration of use of the credit card or the cancellation of the past use declaration. Thus, the credit card owner uses the dial buttons to input information asking for the declaration of use of the credit card. Then, status information for this card number set in the owner database 14 is changed to “1” to permit the credit card with this card number to be used. Further, the apparatus 1 issues an audio message indicating that the use of this credit card has been approved.

On receiving this audio message, the credit card owner subsequently goes out shopping. Then, if the owner purchases any product at the member store, he or she tells a clerk that he or she desires to settle the price with the credit card the use of which has been declared. The clerk operates the member store terminal 4 to read the card number from the credit card and to input credit settlement information such as the amount of the credit and the payment method. Then, this credit settlement information is transmitted to the card authentication server apparatus 1 via the member store private network 5.

The card authentication server apparatus 1 examines the status information corresponding to the card number contained in the credit settlement information received from the member store terminal 4. Then, if the status information is set to “1”, the card authentication server apparatus 1 executes a credit settling process. Once the settlement is completed, card authentication server apparatus 1 transmits a response message to the member store terminal 4 indicating that the price has been settled with the card. On receiving the response message, the member store terminal 4 prints out a credit slip.

Thus, according to the present embodiment, a person who can settle the price at a member store using his or her credit card must use, before shopping, the user terminal 6 to access the card use management center and input authentication information such as his or her code number to the center so as to be identified. Accordingly, the use of the credit card is permitted only when the credit card owner intends to use this card, and those cards which the owner does not intend to use are not permitted to be used. Consequently, the credit card can be reliably prevented from being unfairly used. Furthermore, the user terminal 6 is not limited to a cellular telephone or the like but may be a desktop telephone at home or a public telephone in the downtown area. The owner intending to use the credit card can easily transmit his or her intention to the card use management center. This is not complicated.

Further, only a short time is required at the member store to check whether or not the credit card user is the credit card owner. This is because this time corresponds to the time required by the card authentication server apparatus 11 to check whether or not the credit card about which the member store terminal 4 is inquiring of the card authentication server apparatus 11 has already been permitted to be used. Thus, the flow of the settlement process is not suspended. Therefore, a settling process is executed smoothly at the member store to avoid keeping other clients waiting. This serves to improve the reliability of the store.

Furthermore, the credit card user is not asked to sign when using the card at the member store and need not carry his or her mobile communication terminal such as a cellular telephone with him or her. Therefore, the present invention is practical.

Now, a second embodiment will be described with reference to FIGS. 7 to 9. Also in this embodiment, a credit card user uses his or her credit card to settle the price at a member store. The configuration of the system and the functional configuration of the card authentication server apparatus 1 are similar to those in the first embodiment. Accordingly, FIGS. 1 and 2 will be used as they are, and the corresponding description is omitted.

FIG. 7 is a diagram showing a configuration of the owner database 14 according to the second embodiment. In the second embodiment, the owner database 4 is configured to store not only status information indicating, by way of card numbers, whether or not each of all credit cards owned by the credit card owner is available but also card use conditions including the number of times the card can be used and the time after which the card is no longer available (use limit time). The card use conditions are set when the credit card user declares the use of this credit card.

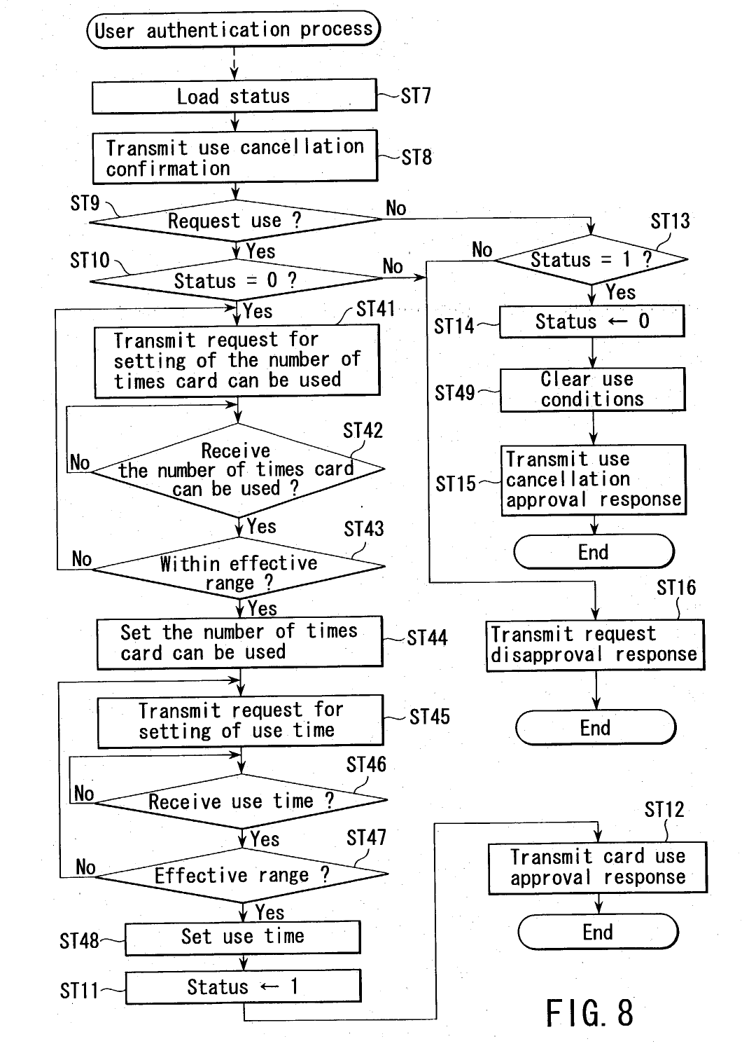

FIG. 8 is a flow chart showing a process procedure executed by the user authentication processing section 16 according to the second embodiment. The same parts as those in FIG. 5, showing the process procedure according to the first embodiment, are denoted by the same reference numerals. The processing in steps ST1 to ST6 is the same as that in the first embodiment and is thus omitted.

The process procedure executed by the user authentication processing section 16 in the second embodiment differs from that in the first embodiment in the following points: the processing executed between steps ST41 and ST48, i.e. after the status information has been confirmed to be “0” at step ST10 and before the status information is changed to “1” at step ST11 if the user terminal 6 inputs, at step ST9, information requesting the declaration of use of the credit card, and the processing executed in step ST49, i.e. after the status information has been changed to “0” at step ST14 and before the audio message is outputted, at step ST15, indicating that the use declaration has been cancelled if the user terminal 6 inputs, at step ST9, information requesting the use declaration to be cancelled.

Specifically, on confirming the status information to be “0” at step ST10, the user authentication processing section 16 provides, at step ST41, the credit card user with an audio guidance requesting him or her to set the number of times the credit card can be used. This audio guidance is, for example, the message “Set the number of times the credit card can be used”. In response to this notification, at step ST42, the user terminal 6 inputs information indicating the number of times the credit card can be used. Then, at step ST43, the user authentication processing section 16 determines whether or not this number of times is within a preset effective range (for example, 1 to 10). If this number is outside the effective range, the procedure returns to step ST41, where the user authentication processing section 16 provides an audio guidance again.

If the number of times inputted by the user terminal 6 is within the effective range, the user authentication processing section 16 sets this number of times in association with the corresponding card number in the owner database 14.

Next, at step ST45, the user authentication processing section 16 provides the credit card user with an audio guidance requesting him or her to set the use limit time of the credit card. This audio guidance is, for example, the message “Set the time by which the use of the credit card must be completed”. In response to this notification, at step ST46, the user terminal 6 inputs information representative of the use limit time. Then, at step ST47, the user authentication processing section 16 determines whether or not this use limit time is within a preset effective range (for example, 8:00 to 24:00). If the duration is outside the effective range, the procedure returns to step ST45, where the user authentication processing section 16 provides an audio guidance again.

If the use limit time inputted by the user terminal 6 is within the effective range, the user authentication processing section 16 sets this duration in association with the corresponding card number in the owner database 14. The procedure subsequently proceeds to step ST11.

Further, after changing the status to “0” at step ST14, the user authentication processing section 16 clears the use conditions (the number of times the card can be used and the use limit time) for the card number corresponding to this status at step ST49. The procedure then proceeds to step ST15.

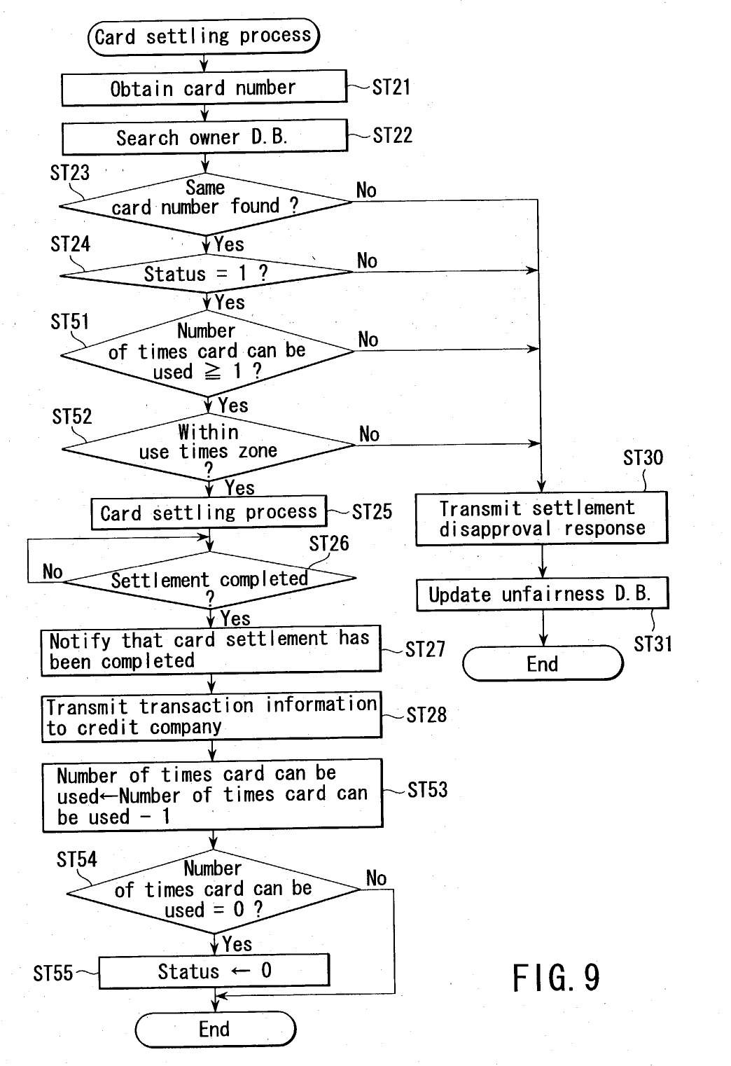

FIG. 9 is a flow chart showing a process procedure executed by the card settlement processing section 17 according to the second embodiment. In FIG. 9, the same parts as those in FIG. 6 are denoted by the same reference numerals. In the second embodiment, at step ST 24, the card settlement processing section 17 confirms that the status information stored in association with the card number is set to “1” (available). Then, at step ST51, the card settlement processing section 17 checks whether or not the number of times the card can be used, which number is stored in association with this card number, is 0 or 1 or more. If this number of times is 1 or more, then at step ST52, the card settlement processing section 17 checks whether or not the transaction time contained in the credit settlement information exceeds the use limit time. Then, if the transaction time does not exceed the use limit time, the procedure proceeds to step ST 26 for a card settling process.

Subsequently, the card settling process is completed. Then, at step ST28, the card settlement processing section 17 transmits transaction information to the host computer 2 at the credit card issuing company. At step ST53, the card settlement processing section 17 subtracts one from the number of times the card can be used which number corresponds to this card number. As a result, only when confirming at step ST54 that this number of times is 0, the card settlement processing section 17 changes the status information corresponding to this card number, to “0” at step ST55.

If at step ST51, the number of times the card can be used is 0 and if at step ST52, the transaction time exceeds the use limit time, the procedure proceeds to step ST30, where the card settlement processing section 17 transmits a response message indicating that the price cannot be settled with this card.

With the second embodiment configured as described above, when using the user terminal 6 to declare the use of the credit card, the credit card user sets the credit use conditions including the two items, i.e. number of times the card can be used and the use limit time. Unless the use limit time for the day is exceeded, the price can be settled by using the credit card up to a set number of times without repeatedly declaring the use of the card. Conversely, the card cannot be used during a time zone exceeding the use limit time or if the number of times the card has been used has reached the set value. Accordingly, the use of the credit card can be restricted under the use conditions, of which the credit card owner is unconscious. This makes the credit card more reliable. Further, owing to the ability to set the number of times the card can be used, it is unnecessary to perform a cumbersome operation of setting the validity of the credit card every time the card is used.

In the second embodiment, the credit use conditions includes the two items, i.e. the number of times the card can be used and a use limit time. However, it is possible to use only one of these items. Alternatively, in addition to the use limit time, the number of days during which the card is available can be set to restrict the use time so that, for example, the card cannot be used after a particular time on a particular day.

Furthermore, as a credit use condition, it is also possible to restrict the use time in such a manner that the card is only available between now and a particular time or for a particular number of hours from now. It is also possible to restrict the use time by setting the day of the week and the time on and at which the card is used.

Alternatively, it is possible to specify member stored at which credits are available. Then, the card can be used only at the specified stores. Therefore, the security of the card is further improved.

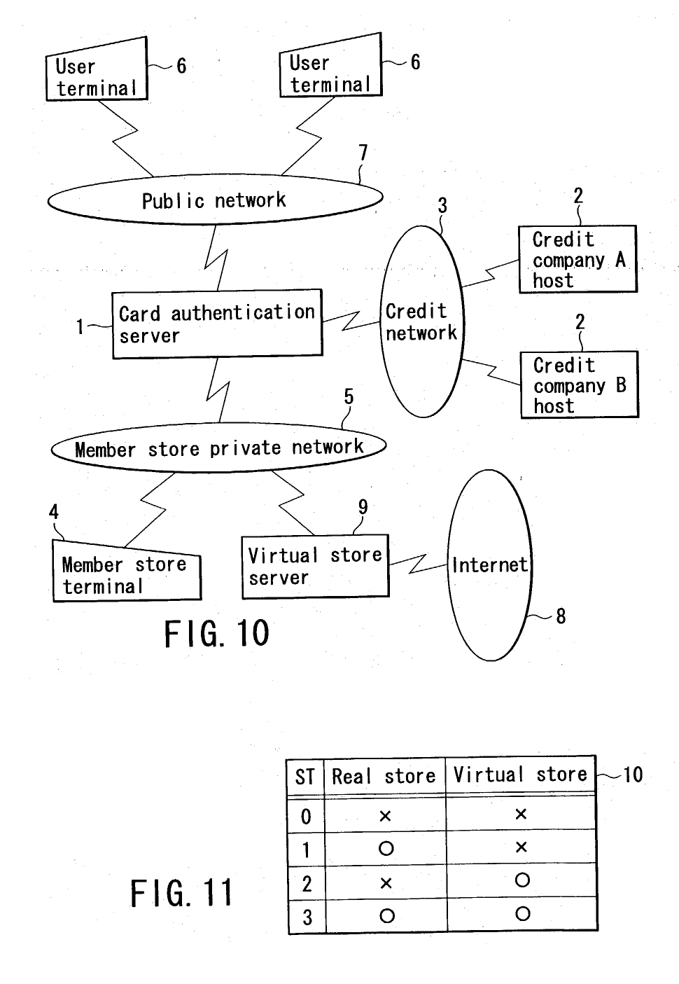

Now, a third embodiment will be described with reference to FIGS. 10 to 13. Also in this embodiment, a credit card user uses his or her credit card to settle the price at a member store. The same parts as those in the above embodiments are denoted by the same reference numerals. Their description is thus omitted.

In the third embodiment, as shown in the diagram in FIG. 10 showing a configuration of a system, the card authentication server apparatus 1 connects not only to the member store terminal 4, which is a product selling and registering terminal at a real store where products are actually sold but also to a virtual store server 9 that is a Web server at a virtual store that delivers and sells products ordered via the Internet 8.

Further, to store, in the owner database 14 of the card authentication server apparatus 1, status information that indicates either an available status or an unavailable status for each card number, a store table 10 is used which stores either the available or unavailable status for each of the real and virtual stores as shown in FIG. 11. In this embodiment, in the status table 10, status information “0” indicates that the card is unavailable at both real and virtual stores. Status information “1” indicates that the card is available only at the real store. Status information “2” indicates that the card is available only at the virtual store. Status information “3” indicates that the card is available at both real and virtual stores.

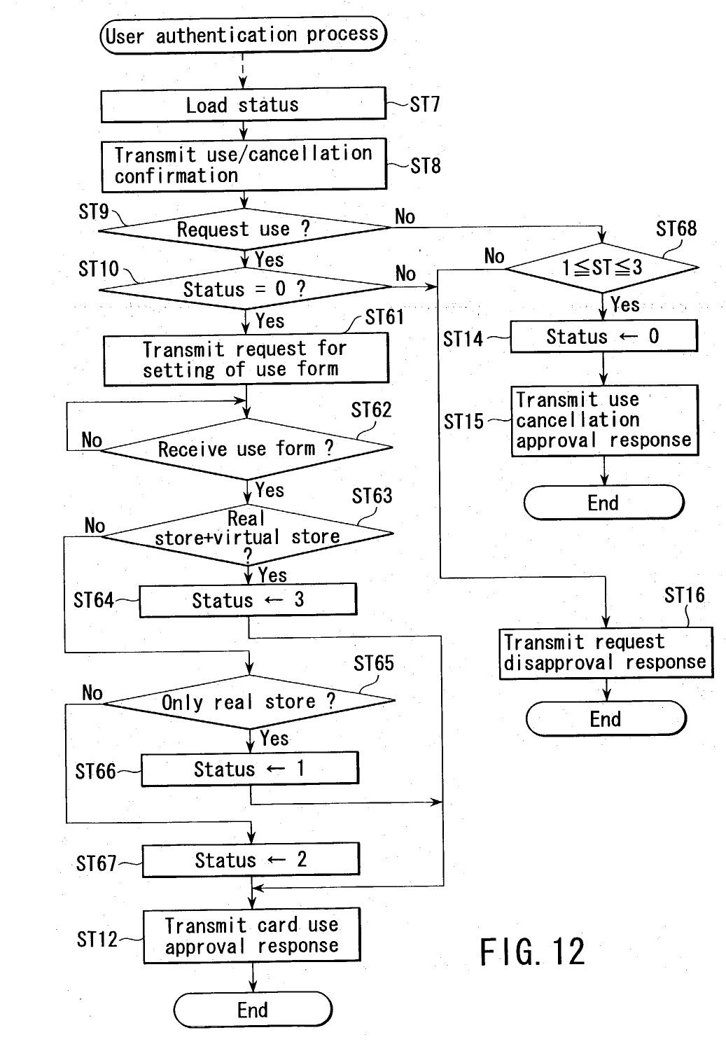

However, the user authentication processing section 16 of the card authentication server apparatus 1 executes the process shown in the flow chart in FIG. 12. Also in FIG. 12, the same parts as those in FIG. 8, showing the process procedure according to the second embodiment, are denoted by the same reference numerals. The processing in steps ST1 to ST6 is the same as that in the second embodiment and is thus omitted.

The process procedure executed by the user authentication processing section 16 in the third embodiment differs from that in the first embodiment in the following point: the processing executed between steps ST61 and ST67, i.e. after the status information has been confirmed to be “0” at step ST10 and before the user authentication processing section 16 provides the use with an audio message indicating that the use of the credit card has been approved if the user terminal 6 inputs information requesting the use declaration at step ST9.

Specifically, on confirming the status information to be “0” at step ST10, the user authentication processing section 16 provides, at step ST61, the credit card user with an audio guidance requesting him or her to set the form of the store at which he or she is to use the credit card. This audio guidance is, for example, the message “Will the credit card be used at the real store or the virtual store, or at both?” In response to this notification, at step ST62, the user terminal 6 inputs information representing the form of the store at which the card is to be used. Then, the user authentication processing section 16 checks this information. Then, at step ST63, if the card is set to be used at both real and virtual stores, then at step ST64, the user authentication processing section 16 changes the corresponding status information to “3” and writes the changed information in the owner database 14. Alternatively, if the card is set to be used only at the real store, then at step ST67, the user authentication processing section 16 changes the corresponding status information to “1” and writes the changed information in the owner database 14. Alternatively, if the card is set to be used only at the virtual store, then at step ST68, the user authentication processing section 16 changes the corresponding status information to “2” and writes the changed information in the owner database 14. Subsequently, the procedure proceeds to step ST12.

Further, if at step ST9, the user terminal 6 inputs information requesting the use declaration to be cancelled, then at step ST68, the user authentication processing section 16 checks the corresponding status information. At step ST68, if the status information is “1”, “2”, or “3”, the procedure proceeds to step ST14. If the status information is “0”, the procedure proceeds to step ST16.

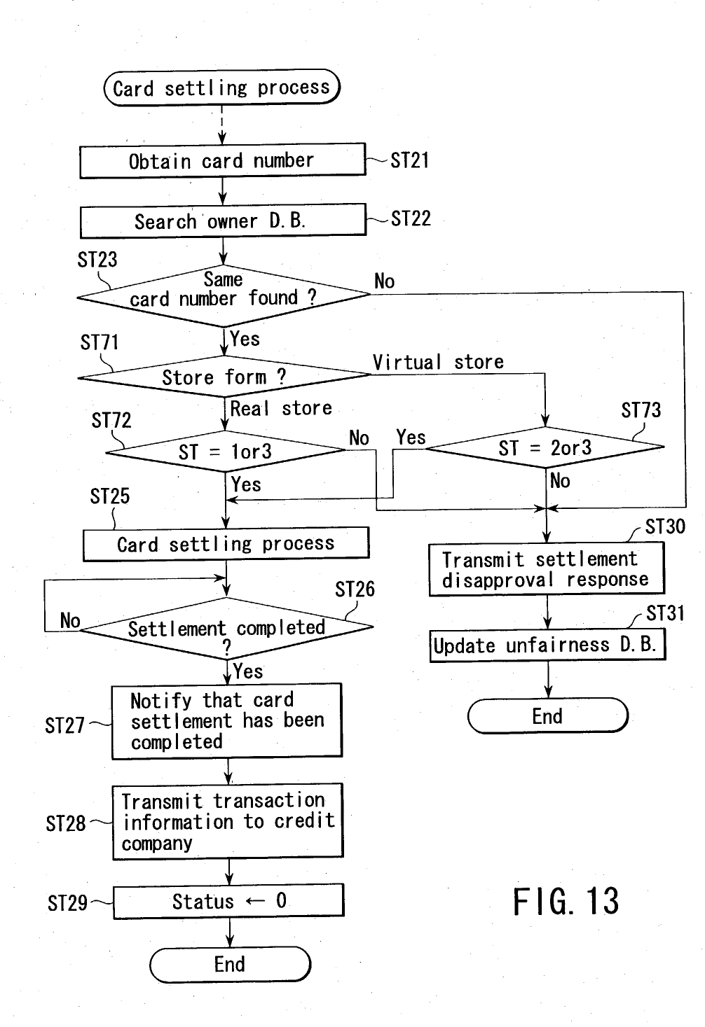

FIG. 13 is a flow chart showing a process procedure executed by the card settlement processing section 17 according to the third embodiment. In FIG. 13, the same parts as those in FIG. 6 are denoted by the same reference numerals. In the third embodiment, if the card settlement processing section 17 confirms that the owner database 14 stores the same card number as that obtained from the credit settlement information at step S23, then it determines at step S71 whether the member store terminal 4 at the real store or the virtual store server 9 at the virtual store has transmitted the credit settlement information. In this regard, the credit settlement information includes information indicating whether the member store terminal 4 at the real store or the virtual store server 9 at the virtual store has transmitted the credit settlement information. If the member store terminal 4 at the real store has transmitted the credit settlement information, then at step ST72, the card settlement processing section 17 determines whether or not the status information “1” or “3” is stored in association with the card number. If the status information “1” or “3” is stored in association with the card number, the procedure proceeds to step ST25 because the credit card is permitted to be used at the real store. If the status information “0” or “2” is stored in association with the card number, the procedure proceeds to step ST30 because the credit card is not permitted to be used at the real store. On the other hand, if the virtual store terminal 9 at the virtual store has transmitted the credit settlement information, then at step ST73, the card settlement processing section 17 determines whether or not the status information “2” or “3” is stored in association with the card number. If the status information “2” or “3” is stored in association with the card number, the procedure proceeds to step ST25 because the credit card is permitted to be used at the virtual store. If the status information “0” or “1” is stored in association with the card number, the procedure proceeds to step ST30 because the credit card is not permitted to be used at the virtual store.

In the third embodiment configured as described above, when using the user terminal 9 to declare the use of the credit card, the credit card user sets, as a credit use condition, the form the store at which the card is used. That is, the user makes a setting as to whether the credit card is to be used at only the real or virtual store or at both. Then, even if, for example, a third person attempts to use the credit card set be available only at the real store to settle the price at the virtual store, this settlement is not approved, thus preventing the unfair use of the card. Likewise, even if a third person attempts to use the credit card set be available only at the virtual store to settle the price at the real store, this settlement is not approved, thus preventing the unfair use of the card. Therefore, the credit card can be made more reliable.

When a card authentication program comprises a program for executing the process shown in the flow charts in FIGS. 5 and 6 and a program for executing the process shown in FIGS. 8 and 9, this program can be supplied to a computer through a medium such as a hard disk or a semiconductor memory which fixedly carries programs or through a medium such as a communication network which fluidly carries programs.

The present invention is not limited to the above embodiments.

For example, in the system in FIG. 1, the credit network 3, the member store private network 5, and the public network 7 are independently provided. However, a network may be constructed by integrating any two of these networks together.

Furthermore, in the system in FIG. 10, the credit network 3, the member store private network 5, the public network 7, and the Internet 8 are independently provided. However, a network may be constructed by integrating any two or three of these networks together.

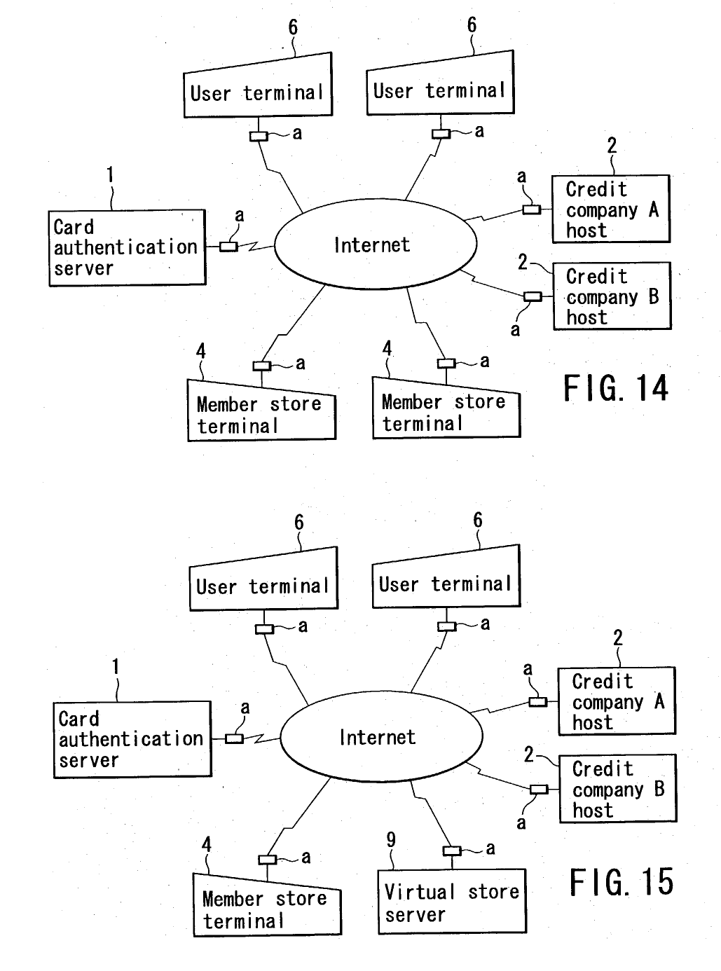

Further, the card authentication server apparatus 1 according to the previously described first embodiment is not limited to the system in FIG. 1. As shown in FIG. 14, it may be connected to the Internet, with a credit company A host 2, a credit company B host 2, the member store terminal 4, and the user terminal 6 similarly connected to the Internet.

Moreover, the card authentication server apparatus 1 according to the previously described third embodiment is not limited to the system in FIG. 10. As shown in FIG. 15, it may be connected to the Internet, with the credit company A host 2, the credit company B host 2, the member store terminal 4, the user terminal 6, and the virtual store server 9 similarly connected to the Internet. In FIGS. 14 and 15, reference character a denotes an exclusive adapter used to construct a VPN (Virtual Private Network).

In the previously described embodiments, the card settlement processing section 17 of the card authentication server apparatus 1 carries out settlement with the credit card. However, the member store terminal 4 or the virtual store server 9 may be used to execute a settlement process by transmitting a settlement approval response to the member store terminal 4 or the virtual store server 9 if the status information for the card number indicates that the credit settlement is available and transmitting a settlement disapproval response to the member store terminal 4 or the virtual store server 9 if the status information for the card number indicates that the credit settlement is unavailable.

Furthermore, the second and third embodiments may be combined together to restrict the number of times the card can be used at the real and virtual stores as well as the use time.

Moreover, in the previously described embodiments, as means for executing authentication to determine whether the credit card user who has declared the use of the credit card via the user terminal 6 actually owns the card, the credit card user is requested to input authentication information such as a code number which is known only by the owner. However, the method for authenticating individuals is not limited to this aspect. For example, each card owner's voice, which is his or her functional characteristic, may be registered in the owner database 14 so that voice data inputted through a telephone that is the user terminal 6 can be compared with the registered voice to determine whether or not the credit card user is the credit card owner.

Further, in the previously described embodiments, description has been given of the settlement system that uses credit cards. However, the present invention is applicable to a debit card settling system that immediately settles the price using a cache card issued by a financial institute such as a bank or a post office.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A card authentication server apparatus connected to a card-available store via a network, the apparatus comprising:
a user information storing section in which at least authentication information and use permission information are stored for each card user;
an authenticating section which operates on receiving declaration of use of the card from the card user, to carry out authentication to determine whether or not the use has been declared by a valid owner of the card, with reference to the user information storing section;
a setting section which operates when the authenticating section has determined that the use has been declared by the valid owner, to set the use permission information in the user information storing section to permit the use of the card;
a confirming section which operates on receiving an approval inquiry from the card-available store about the card used for settlement, to determine whether or not the use permission information in the user information storing section indicates that the use of the card is permitted; and
a notifying section which operates when the confirming section confirms that the use of the card is permitted, to transmit a use permission response to the card-available store.

2. The card authentication server apparatus according to claim 1, further comprising:
a use condition setting section which sets use conditions for the card, and
wherein the card use conditions set by the use condition setting section are stored in the user information storing section,
on receiving on receiving the approval inquiry from the card-available store about the card used for settlement, the confirming section determines whether or not the use permission information in the user information storing section indicates that the use of the card is permitted and whether or not the use of the card meets the card use conditions.

3. The card authentication server apparatus according to claim 2, wherein of the number of times the card can be used and a use limit time, the use conditions include at least the number of times the card can be used.

4. The card authentication server apparatus according to claim 2, wherein the use conditions specify a card-available store.

5. The card authentication server apparatus according to claim 2, wherein the use conditions indicate a store form of the card-available store where the card is used.

6. The card authentication server apparatus according to claim 1, further comprising a card settling section which executes settlement with the card once the confirming section confirms that the use of the card is permitted, and
wherein once the card settling section completes the settlement with the card, the notifying section transmits a use permission response to the card-available store.

7. The card authentication server apparatus according to claim 6, further comprising a use condition setting section which sets use conditions for the card, and
wherein the card use conditions set by the use condition setting section are stored in the user information storing section, and
on receiving the approval inquiry from the card-available store about the card used for settlement, the confirming section determines whether or not the use permission information in the user information storing section indicates that the use of the card is permitted and whether or not the use of the card meets the card use conditions.

8. The card authentication server apparatus according to claim 7, wherein of the number of times the card can be used and the use limit time, the use conditions include at least the number of times the card can be used.

9. The card authentication server apparatus according to claim 7, wherein the use conditions specify a card-available store.

10. The card authentication server apparatus according to claim 7, wherein the use conditions indicate the store form of the card-available store where the card is used.

11. A card authentication program recorded on a recording medium or transmitted via a communication line, the program comprising:
means for operating on receiving declaration of use of the card from the card user, to carry out authentication to determine whether or not the use has been declared by a valid owner of the card, with reference to a user information storing section in which at least authentication information and use permission information are stored for each card user;
means for operating when the authenticating means has determined that the use has been declared by the valid owner, to set the use permission information in the user information storing section to permit the use of the card;
means for operating on receiving an approval inquiry from the card-available store about the card used for settlement, to execute confirmation by determining whether or not the use permission information in the user information storing section indicates that the use of the card is permitted; and
means for operating when the confirming means confirms that the use of the card is permitted, to transmit a use permission response to the card-available store.

12. The card authentication program according to claim 11, further comprising:
means for executing settlement with the card once the confirming means confirms that the use of the card is permitted, and
wherein once the card settling means completes the settlement with the card, a use permission response is transmitted to the card-available store.
